(19) United States
(12) Patent Application Publication
(10) Pub. No.: US 2025/0006907 A1
(43) Pub. Date: Jan. 2, 2025

(54) ELECTROCHEMICAL DEVICE AND ELECTRONIC DEVICE

(71) Applicant: Ningde Amperex Technology Limited, Ningde (CN)

(72) Inventor: Wentao MA, Ningde (CN)

(73) Assignee: Ningde Amperex Technology Limited, Ningde (CN)

(21) Appl. No.: 18/757,815

(22) Filed: Jun. 28, 2024

(30) Foreign Application Priority Data
Jun. 29, 2023 (CN) 202310781570.8

(51) Int. Cl. H01M 4/36; H01M 4/02; H01M 4/38; H01M 4/583; H01M 4/62

(52) U.S. Cl. CPC H01M 4/366; H01M 4/386; H01M 4/583; H01M 4/622; H01M 4/625; H01M 2004/021; H01M 2004/027

(57) ABSTRACT

An electrochemical device includes a negative electrode plate. The negative electrode plate includes a negative current collector and a negative active material layer. The negative active material layer is located on the negative current collector. Along a thickness direction of the negative electrode plate, the negative active material layer includes a first layer and a second layer. The first layer is located between the negative current collector and the second layer. A porosity of the second layer is 5% to 20% higher than a porosity of the first layer. A thickness of the second layer is 5 μm to 20 μm.

### CROSS-REFERENCE TO RELATED APPLICATION

The present application claims priority to Chinese Patent application No. CN 202310781570.8 filed in the China National Intellectual Property Administration on Jun. 29, 2023, the entire content of which is hereby incorporated by reference.

### TECHNICAL FIELD

This application relates to the field of electrochemical energy storage, and in particular, to an electrochemical device and an electronic device.

### BACKGROUND

With the development of electrochemical energy storage technology, higher requirements have been imposed on the energy density and cycle performance of electrochemical devices (such as a lithium-ion battery). To increase the energy density of the electrochemical devices, the coating weight and the compaction density of a negative electrode plate are typically designed to be relatively high. After the negative electrode plate is cold-pressed, the compaction density is not distributed uniformly in a thickness direction of the negative electrode plate. The compaction density of a negative active material layer surface away from the negative current collector is higher than the compaction density of the negative active material layer close to the negative current collector. A dense layer with a thickness of several microns to more than ten microns is formed on the negative active material layer surface away from the negative current collector. The porosity of the dense layer is lower than that of the remainder of the negative active material layer, thereby drastically hindering the diffusion of an electrolyte solution, resulting in an increase of the concentration polarization during high-rate cycling, and deteriorating the kinetic performance. This makes it difficult to intercalate lithium ions during charging, and results in purple specks and even lithium plating and other interface deterioration phenomena, thereby impairing the cycle performance and safety performance of the electrochemical device. Therefore, further improvements in this respect are expected.

### SUMMARY

This application solves the following technical problem: a difference in compaction density between a surface and a body of a negative electrode plate makes a porosity relatively low in the surface of the negative electrode plate, makes it difficult for an electrolyte solution to infiltrate the surface, and results in a low ion conductivity and other problems, thereby giving rise to poor cycle performance.

This application provides an electrochemical device. The electrochemical device includes a negative electrode plate. The negative electrode plate includes a negative current collector and a negative active material layer. The negative active material layer is located on the negative current collector. Along a thickness direction of the negative electrode plate, the negative active material layer includes a first layer and a second layer. The first layer is located between the negative current collector and the second layer. A porosity of the second layer is 5% to 20% higher than a porosity of the first layer. A thickness of the second layer is 5 μm to 20 μm.

In some embodiments, the first layer includes graphite, and the second layer includes at least one of porous graphite or porous graphene. In some embodiments, the porosity of the second layer is 30% to 50%, and the porosity of the first layer is 20% to 30%. In some embodiments, the porosity of the second layer is 39% to 46%.

This application further provides an electrochemical device. The electrochemical device includes a negative electrode plate. The negative electrode plate includes a negative current collector and a negative active material layer. The negative active material layer is located on the negative current collector. Along a thickness direction of the negative electrode plate, the negative active material layer includes a first part and a second part. The first part is located between the negative current collector and the second part. The second part includes a plurality of grooves. A depth of each of the grooves is 1 μm to 10 μm. A porosity of the second part is 3% to 30% higher than a porosity of the first part.

In some embodiments, the porosity of the second part is 25% to 55%, and the porosity of the first part is 20% to 30%. In some embodiments, the porosity of the second part is 35% to 45%. In some embodiments, a diameter of the groove is 1 μm to 50 μm. In some embodiments, a diameter of the groove is 40 μm to 50 μm. In some embodiments, a ratio of an orthogonal projection area of the groove to an orthogonal projection area of the negative active material layer is 0.05 to 0.6. In some embodiments, a ratio of an orthogonal projection area of the groove to an orthogonal projection area of the negative active material layer is 0.3 to 0.5.

An embodiment of this application further provides an electronic device, including the electrochemical device.

By making the porosity of the second layer higher than the porosity of the first layer by 5% to 20% and setting an appropriate thickness of the second layer, this application improves the effect of the electrolyte solution in infiltrating a surface of the negative active material layer, shortens a diffusion distance of lithium ions, reduces concentration polarization, and enhances cycle performance of the electrochemical device. In addition, the thickness of the second layer is controlled to be 5 μm to 20 μm. If the thickness is overly small and less than the thickness of the dense layer, the effect of improving the infiltration is not achieved. If the thickness is overly large, the consumption of the electrolyte solution will increase, thereby adversely affecting the performance of the electrochemical device.

### BRIEF DESCRIPTION OF DRAWINGS

FIG. 1 shows a cross-sectional view of a negative electrode plate sectioned along a width direction according to some embodiments; and

FIG. 2 shows a cross-sectional view of a negative electrode plate sectioned along a width direction according to some embodiments.

### DETAILED DESCRIPTION

The following embodiments enable a person skilled in the art to understand this application more comprehensively, but without limiting this application in any way.

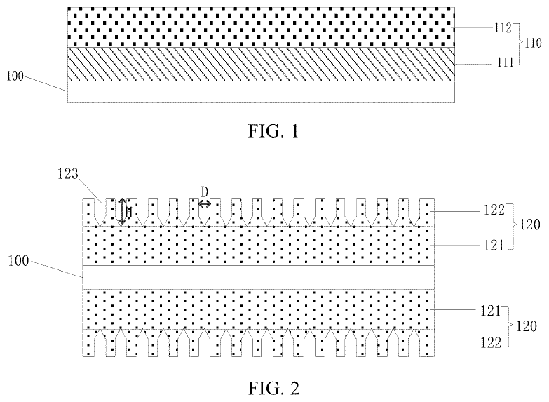

Some embodiments of this application provide an electrochemical device. The electrochemical device includes a negative electrode plate. In some embodiments, the negative electrode plate includes a negative current collector 100 and a negative active material layer 110. The negative active material layer 110 is located on the negative current collector 100. In some embodiments, along a thickness direction of the negative electrode plate, the negative active material layer 110 includes a first layer 111 and a second layer 112. The first layer 111 is located between the negative current collector 100 and the second layer 112. In some embodiments, the first layer 111 and the second layer 112 may exist on one side of the negative current collector 100 (as shown in FIG. 1), or the first layer 111 and the second layer 112 may exist on both sides of the negative current collector 100.

In some embodiments, the porosity of the second layer 112 is 5% to 20% higher than the porosity of the first layer 111. In some embodiments, the thickness of the second layer 112 is 5 μm to 20 μm. By making the porosity of the second layer 112 higher than the porosity of the first layer 111 by 5% to 20% and setting an appropriate thickness (that is, 5 μm to 20 μm) of the second layer 112, this application improves the effect of the electrolyte solution in infiltrating a surface layer, that is, the second layer 112, of the negative active material layer 110, shortens the diffusion distance of lithium ions, reduces concentration polarization, and enhances the cycle performance of the electrochemical device. If the thickness of the second layer 112 is overly small, the thickness of the second layer may be less than the thickness of the cold-pressed dense layer, thereby making the electrolyte solution fail to improve the infiltration. If the thickness is overly large, the consumption of the electrolyte solution will increase, thereby adversely affecting the performance of the electrochemical device.

In some embodiments, the first layer 111 includes graphite. The second layer 112 includes at least one of porous graphite or porous graphene. The porous graphite or porous graphene used in the second layer 112 is a porous material, and can make the porosity of the second layer 112 higher than the porosity of the first layer 111.

In some embodiments, after the electrode plate is cold-pressed, due to the porous structure of the porous graphite or porous graphene, the effect of the dense layer (the second layer 112) in obstructing the electrolyte solution is greatly reduced, thereby reducing concentration polarization. In some embodiments, the porous graphite or porous graphene may be obtained by etching. However, this is merely exemplary, and other appropriate methods may apply. In some embodiments, the etching of the graphite and graphene may be performed by photoetching, catalytic etching, chemical etching, carbon thermal reduction, hydrothermal heating, acid etching, or the like. A commonly used method is chemical etching. For example, using porous graphite as an example, the graphite may be obtained by the following method: mixing graphite with a sulfuric acid solution, where the mass percent of the sulfuric acid is 75% to 100%, the mixing temperature is 20° C. to 100° C., and the mixing time is 10 h to 120 h. With a longer mixing time and a greater concentration of the sulfuric acid, more and larger pores will be etched out, and the porosity will be higher. By controlling the processing parameters, porous graphite or graphene with different porosities can be obtained.

In some embodiments, the porosity of the second layer 112 is 30% to 50%, and the porosity of the first layer 111 is 20% to 30%. If the porosity of the second layer 112 is overly low, the effect of the second layer 112 in improving the infiltration capability of the electrolyte solution is relatively limited. If the porosity of the second layer 112 is overly high, for example, higher than 50%, the second layer 112 will greatly impair the energy density of the negative electrode plate. In some embodiments, the porosity of the second layer is 39% to 46%. In this case, the second layer 112 exerts a relatively significant effect in improving the infiltration capability of the electrolyte solution, and in turn, enhancing the cycle performance but without much impairing the energy density of the negative electrode plate.

In some embodiments, the graphite in the first layer 111 includes at least one of artificial graphite or natural graphite. In some embodiments, the first layer 111 and the second layer 112 each may independently include a silicon-based material. In some embodiments, the silicon-based material includes at least one of silicon, a silicon-oxygen material, a silicon-carbon material, or a silicon-oxygen-carbon material.

In some embodiments, the negative current collector 100 may be at least one of a copper foil, a nickel foil, or a carbon-based current collector. In some embodiments, the first layer 111 and the second layer 112 each may include a dispersant, a conductive agent, and/or a binder. In some embodiments, the dispersant in the first layer 111 and the second layer 112 may include at least one of carboxymethyl cellulose or sodium carboxymethyl cellulose. In some embodiments, the conductive agent in the first layer 111 and the second layer 112 may include at least one of conductive carbon black, Ketjen black, graphite sheets, graphene, carbon nanotubes, or carbon fibers. In some embodiments, the binder in the first layer 111 and the second layer 112 may include at least one of polyacrylic acid, polyvinylpyrrolidone, polyaniline, polyimide, polyamideimide, polysiloxane, styrene butadiene rubber, epoxy resin, polyester resin, polyurethane resin, or polyfluorene. In some embodiments, the mass percent of the graphite in the first layer 111 is 90% to 98%. In some embodiments, the mass percent of the porous graphite and porous graphene in the second layer 112 is 90% to 98%. In some embodiments, the mass ratio between the graphite, the binder, and the dispersant in the first layer 111 may be (90 to 98):(0.2 to 5.6):(1.8 to 5.4). In some embodiments, the mass ratio between the porous graphite (and porous graphene, if any), the binder, and the dispersant in the second layer 112 may be (90 to 98):(0.2 to 5.6):(1.8 to 5.4). Understandably, the mixing ratio of the constituents in the first layer 111 and the second layer 112 is merely an example, and may be any other appropriate mass ratio instead, and the conductive agent is sometimes omissible.

Another embodiment of this application provides an electrochemical device. The electrochemical device includes a negative electrode plate. The negative electrode plate includes a negative current collector 100 and a negative active material layer 120. The negative active material layer 120 is located on the negative current collector 100. Understandably, although the negative active material layer 120 shown in FIG. 2 is located on two sides of the negative current collector 100, the arrangement in the drawing is merely exemplary, and the negative active material layer 120 may be disposed on a single side of the negative current collector 100 instead. In some embodiments, along the thickness direction of the negative electrode plate, the negative active material layer 120 includes a first part 121 and a second part 122. The first part 121 is located between the negative current collector 100 and the second part 122. Understandably, the dashed line in FIG. 2 indicates that there may be no obvious boundary between the first part 121 and the second part 122.

In some embodiments, the second part 122 includes a plurality of grooves 123. In some embodiments, after the negative electrode plate is cold-pressed, holes are punched on the surface of the negative electrode plate by mechanical processing. During the punching, the punched position is vacuum-cleaned or brushed. An exemplary process of mechanical punching is as follows: Cold-pressing the negative electrode plate, placing the cold-pressed negative electrode plate between two steel sheets. Needle-like bulges exist on one side of the steel sheet. The diameter, height, and distribution density of the need-like bulges are adjustable. After the steel sheets are pressed down, the needle-like bulge penetrates into the negative electrode plate to disrupt the surface part of the negative active material layer 120. After the steel sheet is removed, a groove 123 appears on the surface part (the second part 122) of the negative active material layer 120 of the negative electrode plate. Understandably, the above punching method is merely exemplary, and other appropriate punching methods may apply instead, as long as the groove is created in the second part 122. Understandably, the cross-sectional shape of the groove 123 in FIG. 2 is merely exemplary, and the cross-sectional shape of the groove 123 may be another shape such as a rectangle instead.

In some embodiments, a depth H of the groove 123 is 1 μm to 10 μm. If the depth H of the groove 123 is overly small, the effect of the groove 123 in increasing the porosity of the second part 122 is relatively limited. If the depth H of the groove 123 is overly large, the overall energy density of the negative electrode plate will be adversely reduced.

In some embodiments, the porosity of the second part 122 is 3% to 30% higher than the porosity of the first part 121. By making the porosity of the second part 122 higher than the porosity of the first part 121 by 3% to 30%, this application improves the effect of the electrolyte solution in infiltrating the second part 122 that serves as a surface part of the negative active material layer 120, shortens the diffusion distance of lithium ions, reduces concentration polarization, and enhances the cycle performance of the electrochemical device. If the difference in porosity between the second part 122 and the first part 121 is overly small, the effect of the second part 122 in improving the infiltration capability of the electrolyte solution is relatively limited. If the difference in porosity between the second part 122 and the first part 121 is overly large, then the porosity of the second part 122 needs to be increased, thereby unnecessarily reducing the overall energy density of the negative electrode plate.

In some embodiments, the porosity of the second part 122 is 25% to 55%, and the porosity of the first part 121 is 20% to 30%. If the porosity of the second part 122 is overly low, the effect of the second part 122 in improving the infiltration capability of the electrolyte solution is relatively limited. If the porosity of the second part 122 is overly high, for example, higher than 55%, the second part 122 will greatly impair the energy density of the negative electrode plate. In some embodiments, the porosity of the second part 122 is 35% to 45%. In this case, the second part 122 exerts a relatively significant effect in improving the infiltration capability of the electrolyte solution, and in turn, enhancing the cycle performance but without much impairing the energy density of the negative electrode plate.

In some embodiments, a diameter D of the groove 123 is 1 μm to 50 μm. If the diameter D of the groove 123 is overly small, the effect of the second part 122 in improving the infiltration capability of the electrolyte solution is relatively limited. If the diameter D of the groove 123 is overly large, the powder inside the negative active material layer 120 may be squeezed intensely, thereby causing problems such as powder shedding, and in turn, adversely affecting the structural stability of the negative active material layer 120. In some embodiments, the diameter D of the groove 123 is 40 μm to 50 μm. In this case, the second part 122 exerts a relatively significant effect in improving the infiltration capability of the electrolyte solution, and in turn, enhancing the cycle performance.

In some embodiments, a ratio R of an orthogonal projection area of the groove 123 to an orthogonal projection area of the negative active material layer 120 is 0.05 to 0.6. In some embodiments, the ratio R is calculated by the following formula: R=π(D/2)×N/S, where D is the diameter of the groove 123, N is the number of the grooves 123, and S is the coating area of the negative active material layer 120. If the ratio R is overly low, the effect of the second part 122 in improving the infiltration capability of the electrolyte solution is relatively limited. If the ratio R is overly high, the powder inside the negative active material layer 120 may be squeezed intensely, thereby causing problems such as powder shedding. In some embodiments, the ratio of the orthogonal projection area of the groove 123 to the orthogonal projection area of the negative active material layer 120 is 0.3 to 0.5. In this case, the second part 122 exerts a relatively significant effect in improving the infiltration capability of the electrolyte solution, and in turn, enhancing the cycle performance.

In some embodiments, the negative active material layer 120 includes graphite. In some embodiments, the graphite in the negative active material layer 120 includes at least one of artificial graphite or natural graphite. In some embodiments, the negative active material layer 120 includes artificial graphite and a binder. In some embodiments, the negative active material layer 120 may include a silicon-based material. In some embodiments, the silicon-based material includes at least one of silicon, a silicon-oxygen material, a silicon-carbon material, or a silicon-oxygen-carbon material.

In some embodiments, the negative current collector 100 may be at least one of a copper foil, a nickel foil, or a carbon-based current collector. In some embodiments, the negative active material layer 120 may include a conductive agent and a binder. In some embodiments, the conductive agent in the negative active material layer 120 may include at least one of conductive carbon black, Ketjen black, graphite flakes, graphene, carbon nanotubes, or carbon fiber. In some embodiments, the binder in the negative active material layer 120 may include at least one of carboxymethyl cellulose (CMC), polyacrylic acid, polyvinylpyrrolidone, polyaniline, polyimide, polyamideimide, polysiloxane, styrene butadiene rubber, epoxy resin, polyester resin, polyurethane resin, or polyfluorene. In some embodiments, the mass percent of the graphite in the negative active material layer 120 is 90% to 98%. In some embodiments, the mass ratio between the graphite, the binder, and the conductive agent in the negative active material layer 120 may be (90 to 98):(0.2 to 5.6):(1.8 to 5.4). Understandably, the mixing ratio of the constituents in the negative active material layer 120 is merely an example, and may be any other appropriate mass ratio instead, and the conductive agent is sometimes omissible.

In some embodiments, the electrochemical device may further include a positive electrode plate and a separator. The separator is disposed between the positive electrode plate and the negative electrode plate to serve a separation function.

In some embodiments, the positive electrode plate includes a positive current collector and a positive active material layer. The positive active material layer is located on one side or both sides of the positive current collector. In some embodiments, the positive current collector may be an aluminum foil, or may be another positive current collector commonly used in this field. In some embodiments, the thickness of the positive current collector may be 5 μm to 30 μm.

In some embodiments, the positive active material layer may include a positive active material, a conductive agent, and a binder. In some embodiments, the positive active material may include at least one of lithium cobalt oxide, lithium iron phosphate, lithium aluminum oxide, lithium manganese oxide, or lithium nickel cobalt manganese oxide. In some embodiments, the conductive agent in the positive active material layer may include at least one of conductive carbon black, flake graphite, graphene, or carbon nanotubes. In some embodiments, the binder in the positive active material layer may include at least one of polyvinylidene difluoride, poly(vinylidene fluoride-co-hexafluoropropylene), poly(styrene-co-acrylate), poly(styrene-co-butadiene), polyamide, polyacrylonitrile, polyacrylic ester, polyacrylic acid, sodium polyacrylate, sodium carboxymethyl cellulose, polyvinyl acetate, polyvinylpyrrolidone, polyvinyl ether, polymethyl methacrylate, polytetrafluoroethylene, or polyhexafluoropropylene. In some embodiments, a mass ratio of the positive active material, the conductive agent, and the binder in the positive active material layer is (90 to 99):(0.5 to 5):(0.5 to 5), but this is merely an example, and any other appropriate mass ratio may apply.

In some embodiments, the separator includes at least one of polyethylene, polypropylene, polyvinylidene fluoride, polyethylene terephthalate, polyimide, or aramid fiber. For example, the polyethylene includes at least one of high-density polyethylene, low-density polyethylene, or ultra-high-molecular-weight polyethylene. Especially, the polyethylene and the polypropylene are highly effective in preventing short circuits, and can improve stability of the battery through a turn-off effect. In some embodiments, a thickness of the separator falls within a range of approximately 3 μm to 20 μm.

In some embodiments, a surface of the separator may further include a porous layer. The porous layer is disposed on at least one surface of the separator. The porous layer includes inorganic particles and a binder. The inorganic particles are at least one selected from aluminum oxide (Al₂O₃), silicon oxide (SiO₂), magnesium oxide (MgO), titanium oxide (TiO₂), hafnium dioxide (HfO₂), tin oxide (SnO₂), ceria (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide, and barium sulfate. In some embodiments, a diameter of a pore of the separator is within a range of approximately 0.01 μm to 1 μm. The binder in the porous layer is at least one selected from polyvinylidene difluoride, poly(vinylidene difluoride-co-hexafluoropropylene), polyamide, polyacrylonitrile, polyacrylic ester, polyacrylic acid, sodium polyacrylate, sodium carboxymethyl cellulose, polyvinylpyrrolidone, polyvinyl ether, polymethyl methacrylate, polytetrafluoroethylene, and polyhexafluoropropylene. The porous layer on the surface of the separator can improve heat resistance, oxidation resistance, and electrolyte infiltration performance of the separator, and enhance adhesion between the separator and the electrode plate.

In some embodiments of this application, the electrochemical device includes, but is not limited to, a lithium-ion battery. In some embodiments, the electrochemical device further includes an electrolyte solution. The electrolyte solution includes at least one of fluoroether, fluoroethylene carbonate, or ether nitrile. In some embodiments, the electrolyte solution further includes a lithium salt. The lithium salt includes lithium bis(fluorosulfonyl)imide and lithium hexafluorophosphate. The concentration of the lithium salt is 1 mol/L to 2 mol/L. In some embodiments, the electrolyte solution may further include a nonaqueous solvent. The nonaqueous solvent may be a carbonate ester compound, a carboxylate ester compound, an ether compound, another organic solvent, or any combination thereof.

The carbonate ester compound may be a chain carbonate ester compound, a cyclic carbonate ester compound, a fluorocarbonate ester compound, or any combination thereof.

Examples of the chain carbonate ester compound are diethyl carbonate (DEC), dimethyl carbonate (DMC), dipropyl carbonate (DPC), methyl propyl carbonate (MPC), ethylene propyl carbonate (EPC), ethyl methyl carbonate (EMC), or any combination thereof. Examples of the cyclic carbonate ester compound are ethylene carbonate (EC), propylene carbonate (PC), butylene carbonate (BC), vinyl ethylene carbonate (VEC), or any combination thereof. Examples of the fluorocarbonate ester compound are fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methyl ethylene, 1-fluoro-1-methyl ethylene carbonate, 1,2-difluoro-1-methyl ethylene carbonate, 1,1,2-trifluoro-2-methyl ethylene carbonate, trifluoromethyl ethylene carbonate, or any combination thereof.

Examples of the carboxylate ester compound are methyl acetate, ethyl acetate, n-propyl acetate, tert-butyl acetate, methyl propionate, ethyl propionate, propyl propionate, γ-butyrolactone, decanolactone, valerolactone, mevalonolactone, caprolactone, methyl formate, or any combination thereof.

Examples of the ether compound are dibutyl ether, tetraglyme, diglyme, 1,2-dimethoxyethane, 1,2-diethoxyethane, ethoxy-methoxyethane, 2-methyltetrahydrofuran, tetrahydrofuran, or any combination thereof.

Examples of the other organic solvent are dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, or any combination thereof.

An embodiment of this application further provides an electronic device containing the electrochemical device. The electronic device according to this embodiment of this application is not particularly limited, and may be any electronic device known in the prior art. In some embodiments, the electronic device may include, but is not limited to, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, unmanned aerial vehicle, lighting appliance, toy, game console, watch, electric tool, flashlight, camera, large household battery, lithium-ion capacitor, or the like.

Some specific embodiments and comparative embodiments are enumerated below to give a clearer description of this application, using a lithium-ion battery as an example.

### Embodiment 1

Preparing a negative electrode plate: Dissolving artificial graphite as a negative active material, styrene-butadiene rubber as a binder, and sodium carboxymethyl cellulose at a mass ratio of 98:1:1 in deionized water to form a first slurry. Using a 6 μm-thick copper foil as a negative current collector, and applying the first slurry onto both sides of the negative current collector to obtain a first layer, where the coating thickness of the first layer is 100 μm. Dissolving porous graphite as a negative active material, styrene-butadiene rubber as a binder, and sodium carboxymethyl cellulose at a mass ratio of 98:1:1 in deionized water to form a second slurry, where the porous graphite in the second slurry is obtained by acid treatment, and the specific treatment parameters are shown in Table 1. Applying the second slurry onto the first layer to obtain a second layer, where the coating thickness of the second layer is 10 μm. Performing drying, cold-pressing, and slitting to obtain a negative electrode plate.

Preparing a positive electrode plate: Dissolving lithium cobalt oxide as a positive active material, conductive carbon black as a conductive agent, and polyvinylidene difluoride (PVDF) as a binder at a mass ratio of 94.8:2.8:2.4 in an N-methyl-pyrrolidone (NMP) solution to form a positive electrode slurry. Using an 8 μm-thick aluminum foil as a positive current collector, and coating the positive current collector with the positive electrode slurry on both sides, each side being coated for a thickness of 80 μm. Performing drying, cold-pressing, and slitting to obtain a positive electrode plate.

Preparing a separator: Using an 8 μm-thick polyethylene (PE) film as a substrate of the separator, coating both sides of the substrate of the separator with a 2-μm thick aluminum oxide ceramic layer, and finally, applying polyvinylidene fluoride (PVDF) as a binder at a concentration of 2.5 mg/1540.25 mm² onto both sides that have been coated with the ceramic layer, and then drying the coating to obtain a separator.

Preparing an electrolyte solution: Mixing, in an environment with a water content of less than 10 ppm, lithium hexafluorophosphate with a nonaqueous organic solvent to form an electrolyte solution in which a lithium salt concentration is 1.15 mol/L, where the nonaqueous organic solvent contains ethylene carbonate (EC), diethyl carbonate (DEC), propylene carbonate (PC), propyl propionate (PP), and vinylene carbonate (VC) mixed at a mass ratio of 20:30:20:28:2.

Preparing a lithium-ion battery: Stacking the positive electrode plate, the separator, and the negative electrode plate sequentially in such a way that the separator is located between the positive electrode plate and the negative electrode plate to serve a function of separation, and winding the stacked structure to obtain an electrode assembly. Putting the electrode assembly in an aluminum plastic film that serves as an outer package. Dehydrating the electrode assembly at 80° C., injecting the electrolyte solution, and performing packaging. Performing steps such as chemical formation, degassing, and shaping to obtain a lithium-ion battery.

In Comparative Embodiment 1, the coating thickness of the first layer is 110 m, and no second layer exists. Embodiments 2 to 12 differ from Embodiment 1 in the acid concentration, treatment temperature, and treatment time of the acid treatment, or the thickness of the second layer and the porosity of the second layer. Other parameters are the same as those in Embodiment 1, as detailed in Table 1.

In addition, in this application, the corresponding parameters are measured by using the following methods.

### Testing the Porosity of the First Layer and the Second Layer:

Taking a specimen from a cold-pressed electrode plate, and polishing the cross-section of the electrode plate specimen by using an ion beam cross-section polisher (CP). Analyzing the polished cross-section by using a scanning electron microscope (SEM), and analyzing the pores by means of computer image recognition and thresholding to obtain porosities of regions at different depths in the surface of the electrode plate.

### Cycle Test:

Charging a lithium-ion battery at a constant current of 3 C at 0° C. until the voltage increases to a rated voltage of 4.45 V, and then charging the battery at a constant voltage until the current drops to 0.02 C. Leaving the battery to stand for 20 minutes, and then discharging the lithium-ion battery at a current of 1 C until the voltage drops to 3 V, and recording the actual discharge capacity as D₁, thereby completing one cycle. Iterating the above operations for 500 cycles, and recording the capacity in each discharge as Dₙ. Calculating the cycle capacity retention rate as: cycle capacity retention rate=Dₙ/D₁.

Table 1 shows parameters and evaluation results in Embodiments 1 to 12 and Comparative Embodiment 1 separately.

TABLE 1

| | Mass | Acid treatment | Acid | Porosity | Thickness | Porosity | 0° C. 500^{th}-cycle |
|---|---|---|---|---|---|---|---|
| | percent of | temperature | treatment | of first | of second | of second | capacity |
| | sulfuric acid | (° C.) | time (h) | layer | layer (μm) | layer | retention rate |
| Comparative | / | / | / | 24% | / | / | 40% |
| Embodiment 1 | | | | | | | |
| Embodiment 1 | 75% | 20 | 10 | 25% | 10 | 30% | 65% |
| Embodiment 2 | 85% | 20 | 10 | 23% | 10 | 33% | 72% |
| Embodiment 3 | 98% | 20 | 10 | 24% | 10 | 35% | 75% |
| Embodiment 4 | 98% | 60 | 10 | 24% | 10 | 36% | 78% |
| Embodiment 5 | 98% | 80 | 10 | 25% | 10 | 39% | 80% |
| Embodiment 6 | 98% | 100 | 10 | 26% | 10 | 41% | 83% |
| Embodiment 7 | 98% | 60 | 24 | 25% | 10 | 39% | 81% |
| Embodiment 8 | 98% | 60 | 48 | 24% | 10 | 41% | 83% |
| Embodiment 9 | 98% | 60 | 72 | 25% | 10 | 43% | 85% |
| Embodiment 10 | 98% | 60 | 120 | 26% | 10 | 46% | 87% |
| Embodiment 11 | 98% | 60 | 48 | 25% | 20 | 40% | 82% |
| Embodiment 12 | 98% | 60 | 48 | 26% | 5 | 34% | 75% |

As can be seen from Embodiments 1 to 12 versus Comparative Embodiment 1, by forming a second layer of a relatively high porosity on the surface of the negative electrode plate by use of porous graphite, this application increases the cycle capacity retention rate of the lithium-ion battery.

As can be seen from comparison of Embodiments 1 to 3, with the increase of the sulfuric acid concentration in the acid treatment, the porosity of the second layer formed of the porous graphite increases, and the cycle capacity retention rate of the lithium-ion battery increases.

As can be seen from comparison of Embodiments 3 to 6, with the increase of the temperature of the acid treatment, the porosity of the second layer formed of the porous graphite increases, and the cycle capacity retention rate of the lithium-ion battery increases.

As can be seen from comparison of Embodiments 7 to 10, with the increase of the acid treatment time, the porosity of the second layer formed of the porous graphite increases, and the cycle capacity retention rate of the lithium-ion battery increases.

As can be seen from comparison of Embodiments 8, 11, and 12, with the increase of the thickness of the second layer, the porosity of the second layer increases first and then becomes relatively stable, and the cycle capacity retention rate of the lithium-ion battery increases first and then becomes relatively stable.

Embodiment 13 differs from Embodiment 1 in the preparation of the negative electrode plate. Specifically, the preparation steps of the negative electrode plate in Embodiment 13 are as follows: Dissolving artificial graphite as a negative active material, styrene-butadiene rubber as a binder, and sodium carboxymethyl cellulose at a mass ratio of 98:1:1 in deionized water to form a negative electrode slurry. Using a 6 km-thick copper foil as a negative current collector, and applying the negative electrode slurry onto both sides of the negative current collector to obtain a negative active material layer, where the coating thickness of the negative active material layer is 110 μm. Performing drying, cold-pressing, slitting, and punching to obtain a negative electrode plate. The parameters of the grooves obtained by punching are shown in Table 2.

Embodiments 14 to 25 differ from Embodiment 13 in the depth, diameter, and ratio of the grooves. Other parameters are the same as those in Embodiment 13, as detailed in Table 2.

TABLE 2

| | | | | | Porosity | 0° C. 500^{th}-cycle |
|---|---|---|---|---|---|---|
| | Depth H of | Diameter of | | Porosity of | of second | capacity |
| | groove (μm) | groove (μm) | Ratio R | first part | part | retention rate |
| Comparative | / | / | / | 25% | / | 40% |
| Embodiment 1 | | | | | | |
| Embodiment 13 | 1 | 10 | 10% | 26% | 29% | 55% |
| Embodiment 14 | 3 | 10 | 10% | 25% | 31% | 70% |
| Embodiment 15 | 5 | 10 | 10% | 24% | 34% | 73% |
| Embodiment 16 | 10 | 10 | 10% | 27% | 35% | 75% |
| Embodiment 17 | 5 | 20 | 10% | 23% | 36% | 74% |
| Embodiment 18 | 5 | 30 | 10% | 25% | 38% | 78% |
| Embodiment 19 | 5 | 40 | 10% | 24% | 39% | 80% |
| Embodiment 20 | 5 | 50 | 10% | 24% | 39% | 81% |
| Embodiment 21 | 5 | 20 | 20% | 25% | 42% | 82% |
| Embodiment 22 | 5 | 20 | 30% | 24% | 45% | 85% |
| Embodiment 23 | 5 | 20 | 40% | 26% | 48% | 87% |
| Embodiment 24 | 5 | 20 | 50% | 25% | 50% | 88% |
| Embodiment 25 | 5 | 20 | 60% | 25% | 53% | 78% |

As can be seen from Embodiments 13 to 25 versus Comparative Embodiment 1, the grooves are formed on the surface of the negative active material layer by punching, this application increases the cycle capacity retention rate of the lithium-ion battery.

As can be seen from comparison of Embodiments 13 to 16, with the increase of the depth of the grooves, the cycle capacity retention rate of the lithium-ion battery increases.

As can be seen from comparison of Embodiments 17 to 20, with the increase of the diameter of the grooves, the cycle capacity retention rate of the lithium-ion battery increases.

As can be seen from comparison of Embodiments 21 to 25, with the increase of the ratio R of the orthogonal projection area of the groove to the orthogonal projection area of the negative active material layer, the cycle capacity retention rate of the lithium-ion battery shows a tendency to increase first and then decrease.

What is described above is merely exemplary embodiments of this application and the technical principles thereof. A person skilled in the art understands that the scope of disclosure in this application is not limited to the technical solutions formed by a specific combination of the foregoing technical features, but covers other technical solutions formed by arbitrarily combining the foregoing technical features or equivalents thereof, for example, a technical solution formed by replacing any of the foregoing features with a technical feature disclosed herein and serving similar functions.

What is claimed is:

1. An electrochemical device, wherein the electrochemical device comprises:
a negative electrode plate, wherein the negative electrode plate comprises a negative current collector and a negative active material layer, and the negative active material layer is located on the negative current collector;
along a thickness direction of the negative electrode plate, the negative active material layer comprises a first layer and a second layer, and the first layer is located between the negative current collector and the second layer; and
a porosity of the second layer is 5% to 20% higher than a porosity of the first layer, and a thickness of the second layer is 5 μm to 20 μm.

2. The electrochemical device according to claim 1, wherein the first layer comprises graphite, and the second layer comprises at least one of porous graphite or porous graphene.

3. The electrochemical device according to claim 2, wherein the graphite in the first layer includes at least one of artificial graphite or natural graphite.

4. The electrochemical device according to claim 2, wherein the first layer and the second layer each independently include a silicon-based material.

5. The electrochemical device according to claim 4, wherein the silicon-based material includes at least one of silicon, a silicon-oxygen material, a silicon-carbon material, or a silicon-oxygen-carbon material.

6. The electrochemical device according to claim 2, wherein a mass percent of the graphite in the first layer is 90% to 98%, and a mass percent of the porous graphite and porous graphene in the second layer is 90% to 98%.

7. The electrochemical device according to claim 1, wherein the porosity of the second layer is 30% to 50%, and the porosity of the first layer is 20% to 30%.

8. The electrochemical device according to claim 7, wherein the porosity of the second layer is 39% to 46%.

9. The electrochemical device according to claim 1, wherein the negative current collector is at least one of a copper foil, a nickel foil, or a carbon-based current collector.

10. The electrochemical device according to claim 1, wherein the first layer and the second layer each include a dispersant and a conductive agent, wherein the dispersant includes at least one of carboxymethyl cellulose or sodium carboxymethyl cellulose; and
the conductive agent includes at least one of conductive carbon black, Ketjen black, graphite sheets, graphene, carbon nanotubes, or carbon fibers.

11. The electrochemical device according to claim 1, the first layer and the second layer each include a binder; wherein the binder includes at least one of polyacrylic acid, polyvinylpyrrolidone, polyaniline, polyimide, polyamideimide, polysiloxane, styrene butadiene rubber, epoxy resin, polyester resin, polyurethane resin, or polyfluorene.

12. An electronic device, comprising an electrochemical device wherein the electrochemical device comprises:
a negative electrode plate, wherein the negative electrode plate comprises a negative current collector and a negative active material layer, and the negative active material layer is located on the negative current collector;
along a thickness direction of the negative electrode plate, the negative active material layer comprises a first layer and a second layer, and the first layer is located between the negative current collector and the second layer; and
a porosity of the second layer is 5% to 20% higher than a porosity of the first layer, and a thickness of the second layer is 5 μm to 20 μm.

13. The electronic device according to claim 12, wherein the first layer comprises graphite, and the second layer comprises at least one of porous graphite or porous graphene.

14. The electronic device according to claim 13, wherein the graphite in the first layer includes at least one of artificial graphite or natural graphite.

15. The electronic device according to claim 13, wherein the first layer and the second layer each independently include a silicon-based material.

16. The electronic device according to claim 15, wherein the silicon-based material includes at least one of silicon, a silicon-oxygen material, a silicon-carbon material, or a silicon-oxygen-carbon material.

17. The electronic device according to claim 13, wherein a mass percent of the graphite in the first layer is 90% to 98%, and a mass percent of the porous graphite and porous graphene in the second layer is 90% to 98%.

18. The electronic device according to claim 12, wherein the porosity of the second layer is 30% to 50%, and the porosity of the first layer is 20% to 30%.

19. The electronic device according to claim 18, wherein the porosity of the second layer is 39% to 46%.

20. The electronic device according to claim 12, wherein the negative current collector is at least one of a copper foil, a nickel foil, or a carbon-based current collector.
